(19) United States
(12) Patent Application Publication
(10) Pub. No.: US 2009/0241851 A1
(43) Pub. Date: Oct. 1, 2009

(54) FOLDABLE LINER FOR A CAT LITTER BOX

(76) Inventor: Justin T. Peddycoart, Bethel, MN (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 12/409,065

(22) Filed: Mar. 23, 2009

Related U.S. Application Data
(60) Provisional application No. 61/039,333, filed on Mar. 25, 2008.

(51) Int. Cl. A01K 29/00

(52) U.S. Cl. 119/168

(57) ABSTRACT

A disposable liner for placing in a litter box protects the litter box from soil deposited by cats and other pets. The liner has side and end walls projecting upwardly from a floor. Each of the longer side walls has a discontinuity that serves as a fold feature allowing the liner to be folded along a fold line into a folded configuration with the two sections of the floor on either side of the fold in facing relationship. In the folded configuration, the side walls overlap to form a partially closed space for retaining pet waste prior to disposal of the lining.

### CLAIM OF PRIOR APPLICATION FILING DATE

This is a regular application filed under 35 U.S.C. § 111(a) claiming priority under 35 U.S.C. § 119(e) (1), of provisional application Ser. No. 61/039,333, filed Mar. 25, 2008. This regular application incorporates by reference, the provisional application in its entirety.

### BACKGROUND OF THE INVENTION

The invention solves a significant problem in handling and disposing of pet wastes, particularly cat wastes.

Cats have been companion animals for millennia. They are friendly creatures that require minimal care, in that they typically eat what they need (as opposed to dogs, who usually eat what they want), and can be trained to excrete urine and feces in a particular place. Normally, cats kept indoors are now trained to excrete in a litter box.

A litter box is a small tray usually 8-10 in. wide and 12-14 in. long, with perhaps 2-3 in. high walls. An absorbent material such as bentonite or chopped cellulose (litter) is placed in the litter box. The cat's excretions soak into the litter. Current litter formulations to some extent neutralize the odor and prevent the cat from tracking excretions around the dwelling. These features may be inherent in the litter material, or may result from additives in the litter formulation.

In spite of the advances in this area, to prevent unpleasant odors and to prevent a cat from tracking excretions, it is still necessary to frequently remove and dispose of the litter. This is a messy and repetitive task for the cat owner.

Loose litter has other problems as well. First of all, the cat may track the litter around the house, creating a mess and possibly staining rugs and floors.

Secondly, some types of loose litter such as silica bentonite may not be healthy for either cats or their owners. A cat is prone to licking its fur and paws. When or if such litter adheres to its body, the cat will ingest some of the litter while licking itself. The ingested litter may then swell in the digestive tract, creating blockages that are potentially dangerous health problems for the animal.

### BRIEF DESCRIPTION OF THE INVENTION

A disposable litter box liner formed of a flexible sheet material has the general shape of a pan. The liner has a rectangular floor sized to fit within a litter box. Two side walls extend upwardly from edges of the floor. Two end walls extend upwardly from edges of the floor between the two side walls, and are fastened to the side walls in the shape of a pan.

Preferably, each side wall has between the end walls, a discontinuity that forms a fold feature that allows folding of the liner on a fold line on the floor to place the surfaces of the floor on either side of the fold line in an approximate facing relationship. The folded surfaces of the floor in cooperation with the side walls, form a space for retaining loose pet waste in the course of disposal.

The discontinuity in the side walls may take the form of gussets or of overlapping wall segments.

The liner's end walls may have upwardly extending tabs that serve as handles.

The liner's walls may slant outwardly from the floor to allow a number of liners to compactly nest together.

### BRIEF DESCRIPTION OF THE DRAWINGS

FIG. 1 is a perspective view of the litter box liner invention in its normal usage configuration.

FIG. 2 is a perspective view of the invention in its folded configuration.

FIG. 3 is a side elevation view of an alternative embodiment of a side wall of the invention.

FIG. 4 is an edge view of the construction of sheet material suitable for forming the invention.

FIG. 5 is an end elevation view of a stack of liners illustrating how they nest with each other.

### DESCRIPTION OF THE PREFERRED EMBODIMENTS

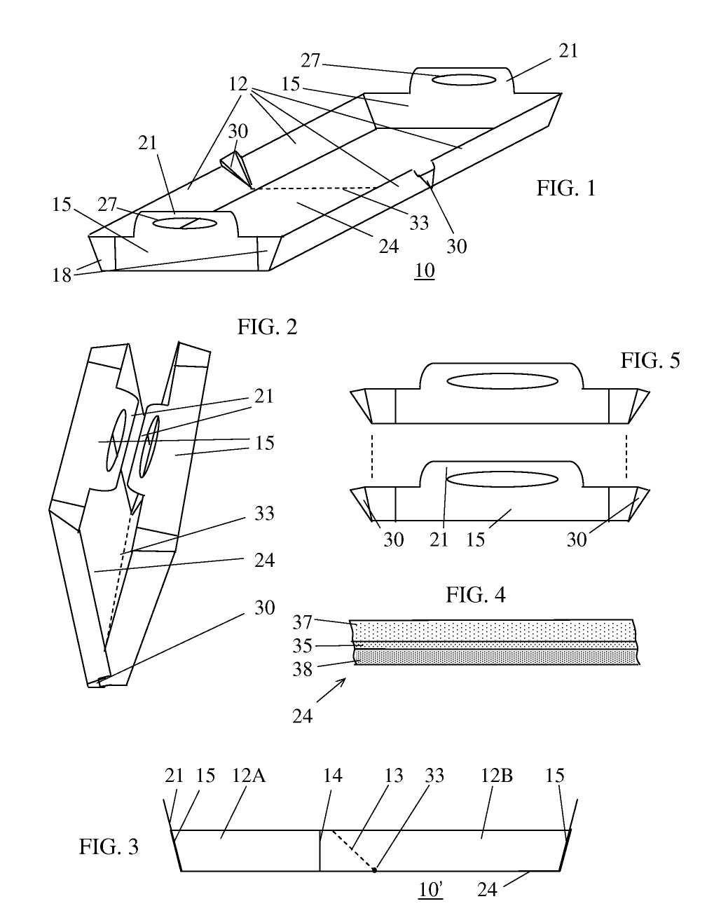

FIG. 1 shows a litter box liner 10 comprising one or more sheets of material formed by folding or molding into a rectangular tray or pan shape. Liner 10 has opposite facing long side walls 12 and opposite facing shorter end walls 15 and a floor 24. In the embodiment of FIGS. 1-3, each of the walls 12 and 15 are attached at their ends to the two adjacent walls 12 or 15 and to floor 24.

Liner 10 is sized to fit inside a litter box. Litter boxes almost always have first and second facing sides of equal length that are shorter than the third and fourth sides. Several different sizes for litter boxes exist. The dimensions of a liner 10 should approximately match the litter box holding it, so as to support the walls 12 and 15.

Liner 10 receives feces and urine that a cat for example deposits, to thereby prevent soiling of the litter box itself. “Loose soil” or “loose waste” includes cat feces unattached to floor 24.

The liner 10 preferably comprises a sheet material having a first moisture-resistant outer (lower) ply or layer and a second moisture-absorbent inner (upper) ply or layer that faces upward and inward to form the interior of liner 10. The upper ply absorbs urine and watery or runny fecal matter. The moisture-resistant outer ply or layer prevents fluid from escaping an individual liner 10. Preferred sheet material is flexible and easily bent.

To form a liner 10, the sheet material is first cut into the appropriate shape, and then is folded along generally orthogonal intersecting bend lines to define side walls 12 and end walls 15. Preferably, walls 12 and 15 slant upwards and outwards from floor 24 to each form an obtuse interior angle with floor 24 of perhaps 95-105°.

A number of possibilities exist for folding and attaching the ends of walls 12 and 15 to each other to form liner 10. FIG. 1 shows one arrangement with ends of walls 12 having integral tabs 18 bent at about 90° to contact the adjacent end surfaces of walls 15 and fasten thereto with staples or adhesive.

The upper edges of end walls 15 may comprise tabs or projections 21 extending above the plane defined by the upper edges of the adjacent side walls 12. Tabs 21 may have cutouts or openings 27 to form handles for lifting a liner 10 from a litter box. The extra spacing of these openings 21 from floor 24 reduces the likelihood that the surrounding sheet material may be soiled by the animal during use.

The structure of liner 10 shown in FIG. 1 simplifies disposal when soiled. Each side wall 12 includes a discontinuity in the form of a fold feature that allows liner 10 to easily fold along a fold line 33 on floor 24 to collapse or close liner 10 into a configuration substantially as shown in FIG. 2. In this folded configuration, parts of floor 24 on each side of fold line 33 are in approximate facing relationship. The side walls 12 and the floor 24 cooperate to form a partially closed space for containing loose soil. In this configuration with tabs 21 close to each other, loose soil lying on the surface of floor 24 rolls or slides to the crease in floor 24 along fold line 33 formed by folding.

In the embodiment of FIGS. 1 and 2, the centers of walls 12 have gussets 30 that serve as the fold feature. Gussets 30 add extra sheet material to side walls 12, particularly along the upper edges, and extend to near floor 24 in an approximate V shape. Fold line 33 extends on floor 24 between gussets 30.

Folding liner 10 to juxtapose tabs 21 also forms a crease along fold line 33. During folding in this way, gussets 30 collapse and in so doing, assist folding along fold line 33. FIG. 2 shows a liner 10 folded along fold line 33. Scoring along fold line 33 may allow easier folding. Gussets 30 close the space formed by folded liner 10 at the ends of fold line 33 to reduce the possibility of loose soil falling from folded liner 10. The two halves of liner 10 on either side of fold line 33 may each bend slightly as tabs 21 near each other and segments 12A contact floor 24.

Gussets 30 may comprise sheet material thinner and more flexible than that comprising other parts of liner 10, and may be bonded onto walls 12. Or liner 10 may comprises walls 12 non-integral from and bonded to floor 24, in which case gussets 30 may be integral with walls 12.

FIG. 3 shows a side elevation view of a liner 10′ having a second configuration for a wall 12 with a fold feature. (FIG. 3 shows only one wall 12.) The wall 12 of FIG. 3 has a pair of overlapping walls segments 12A and 12B that serve as a fold feature to assist folding a liner 10′ into a configuration similar to that of FIG. 2. Wall segment 12A is adjacent to the inside surface of wall segment 12B where segments 12A and 12B overlap. At fold line 33, an edge 13 of segment 12A slants up and back so that the upper edge of segment 12A is shorter than the lower edge of segment 12A (where segment 12A intersects floor 24). Fold line 33 in FIG. 3 is perpendicular to the plane of the paper and thus shows as a point.

In overlapping segment 12A, wall segment 12B extends past edge 13 to a substantially vertical edge 14. In FIG. 3, the right edge 13 of wall 12A is shown as a dotted line because wall 12B is interposed between wall 12A and the viewer where walls 12A and 12B overlap. Because no connection exists between the adjacent ends 13 and 14 of segments 12A and 12B, wall 12 adds little resistance to bending of floor 24 along fold line 33.

When liner 10′ is folded along line 33 for disposal, the overlap of segments 12A and 12B limits the escape of loose soil a cat has previously deposited in liner 10′. The slanted edge 13 on each segment 12A seals against floor 24 when in the folded configuration to hold loose soil material within the space formed by folded liner 10′. The two halves of liner 10′ on either side of fold line 33 may each bend slightly as tabs 21 near each other and segments 12A contact floor 24.

FIG. 4 shows an edge view of one preferred structure for the sheet material comprising floor 24 and likely, the entire liner 10. A base sheet 38 may comprise beverage cardboard on the order of 5-15 mils (0.13-0.4 mm.) thick. The inner surface of base sheet 38 has a thin moisture-resistant coating 35. An absorbent inner ply 37 on the order of 5-15 mils (0.13-0.4 mm.) thick adheres to coating 35. Inner ply 37 may have an upper surface with a relatively rough or nubby texture that appeals to and attracts cats.

At least two sources for suitable material for ply 37 exist:

Absorbent Technologies, Inc., Beaverton, Oreg. 97008 has a product called “Zeba.”
Archer Daniels Midland Co., Decatur Ill. 62526 has a product called Lysorb 218.

FIG. 5 shows how the angled walls 12 and 15 allow a number of the liners 10 to form a compact nested stack that can be placed in a litter box. This nesting allows a number of nested liners 10 to provide additional support of the top liner 10 in a nest. Likely, a cat owner will remove a liner 10 each day or after the liner 10 is soiled, exposing a fresh liner 10 beneath the one removed. Ply 38 prevents liquid deposited on the top liner 10 from leaking to liners 10 beneath it.

What we claim is:

1. A litter box liner formed of a flexible sheet material in the general shape of a pan, said liner having a rectangular floor sized to fit within a litter box, said liner having two side walls extending upwardly from edges of the floor and between the two side walls, two end walls extending upwardly from edges of the floor and fastened to the side walls to form a pan-shaped space, each said side wall having a fold feature between the end walls, said fold feature allowing folding of the liner on a fold line on the floor to place the surfaces of the floor in an approximate facing relationship to thereby form with the side walls, a space for retaining loose soil.

2. The liner of claim 1 wherein a fold feature in a side wall comprises a gusset.

3. The liner of claim 1, wherein a fold feature in each side wall comprises overlapping first and second segments of the side wall.

4. The liner of claim 3, wherein each second overlapping segment in a side wall has an inside surface facing the other side wall, wherein each first overlapping segment lies adjacent to the inside surface of the second overlapping segment, and wherein each first overlapping segment has a slanted edge.

5. The litter box liner of claim 1, wherein the flexible sheet material has a moisture-absorbent ply forming the inner surface of the liner and a moisture-resistant outer ply forming the outer surface of the liner.

6. The litter box liner of claim 1, wherein each wall forms an obtuse interior angle with the floor.

7. A plurality of similar litter box liners according to claim 6, stacked in a nested configuration.

8. The litter box liner of claim 1, wherein the end walls each include a tab projecting above a plane defined by the upper edges of the side walls, and wherein each tab includes an opening.

9. The litter box liner of claim 1, wherein the fold line is scored.
